(19) United States
(12) Patent Application Publication
(10) Pub. No.: US 2009/0220313 A1
(43) Pub. Date: Sep. 3, 2009

(54) Electric Drill Attachment

(76) Inventors: Eric R. Brink, Atascadero, CA (US); Anna L. Brink, Atascadero, CA (US)

Correspondence Address: CROSSLEY PATENT LAW, 236 South Third Street, #287, MONTROSE, CO, 81401, US

(21) Appl. No.: 12/041,271

(22) Filed: Mar. 3, 2008

(51) Int. Cl. B23G 11/00

(52) U.S. Cl. 408/67

(57) ABSTRACT

An electric drill attachment that is designed to be mounted on a standard, portable electric drill and serve both as a depth gauge and a debris remover to remove shavings from the area surrounding a hole during drilling operations. The attachment has a looped section which is fixedly attached to a particular point of a drill bit in use with an electric drill. An elongated plate is attached to the looped section and extends both outward and downward from the looped section, with the plate acting as a sweeping device to sweep away debris and shavings from the area surrounding a hole during drilling operations.

### BACKGROUND OF THE INVENTION

The present invention concerns that of a new and improved electric drill attachment that is designed to be mounted on a standard, portable electric drill, and serve both as a depth gauge and a debris remover to remove shavings from the area surrounding a hole during drilling operations.

### SUMMARY OF THE INVENTION

The present invention concerns that of a new and improved electric drill attachment that is designed to be mounted on a standard, portable electric drill, and serve both as a depth gauge and a debris remover to remove shavings from the area surrounding a hole during drilling operations. The attachment has a looped section which is fixedly attached to a particular point of a drill bit in use with an electric drill. An elongated plate is attached to the looped section and extends both outward and downward from the looped section, with the plate acting as a sweeping device to sweep away debris and shavings from the area surrounding a hole during drilling operations.

There has thus been outlined, rather broadly, the more important features of an electric drill attachment that the detailed description thereof that follows may be better understood and in order that the present contribution to the art may be better appreciated. There are, of course, additional features of the electric drill attachment that will be described hereinafter and which will form the subject matter of the claims appended hereto.

In this respect, before explaining at least one embodiment of the electric drill attachment in detail, it is to be understood that the electric drill attachment is not limited in its application to the details of construction and to the arrangements of the components set forth in the following description or illustrated in the drawings. The electric drill attachment is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the electric drill attachment. It is important, therefore, that the claims be regarded as including such equivalent constructions insofar as they do not depart from the spirit and scope of the present invention.

It is therefore an object of the present invention to provide an electric drill attachment which has all of the advantages of the prior art and none of the disadvantages.

It is another object of the present invention to provide an electric drill attachment which may be easily and efficiently manufactured and marketed.

It is another object of the present invention to provide an electric drill attachment which is of durable and reliable construction.

It is yet another object of the present invention to provide an electric drill attachment which is economically affordable and available for relevant market segment of the purchasing public.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a front perspective view of the electric drill attachment.

FIG. 2 shows a front end view of the electric drill attachment.

FIG. 3 shows a rear end view of the electric drill attachment.

FIG. 4 shows a top view of the electric drill attachment.

FIG. 5 shows a bottom view of the electric drill attachment.

FIG. 6 shows a side view with the electric drill attachment being attached to a drill bit attached to a drill, highlighting the electric drill attachment as it would appear in use.

### DESCRIPTION OF THE PREFERRED EMBODIMENT

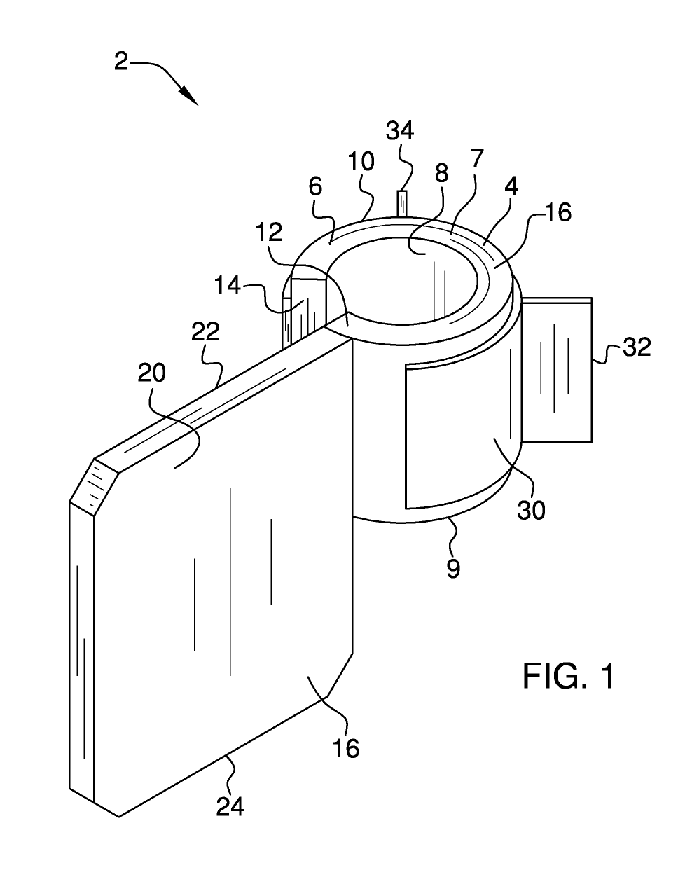

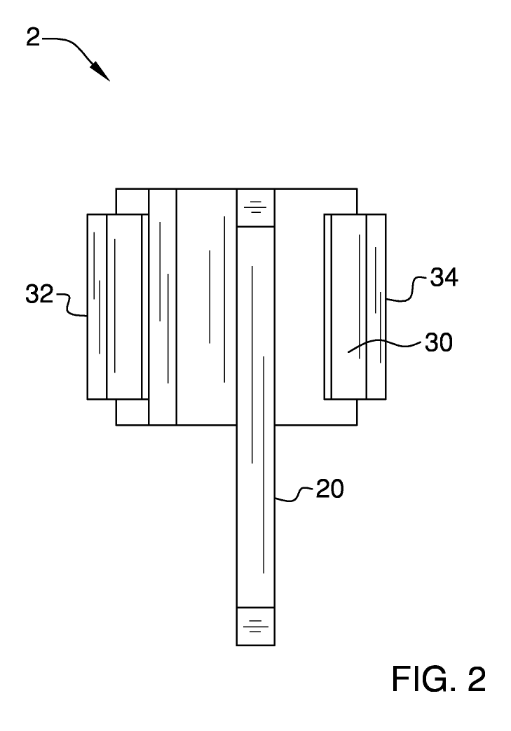

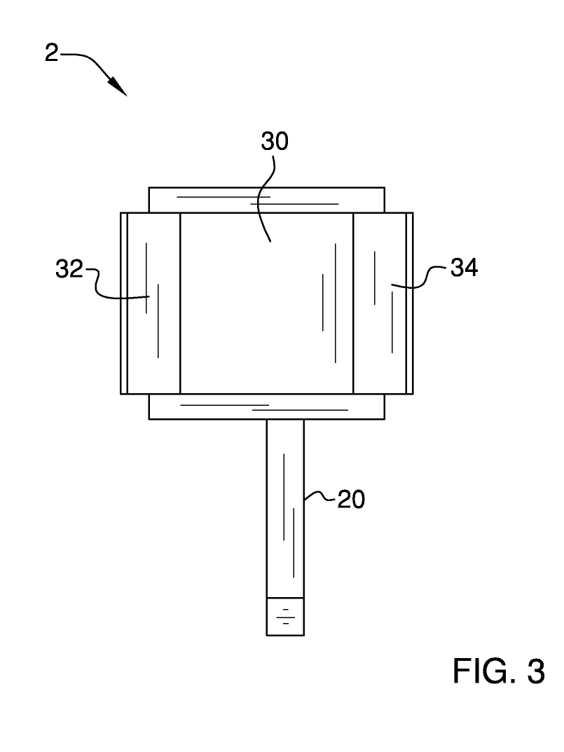

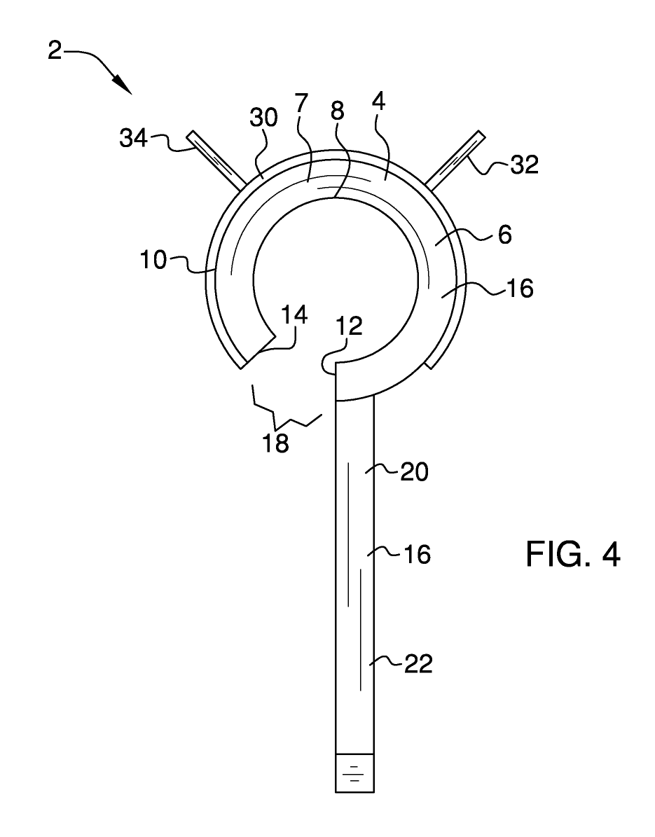

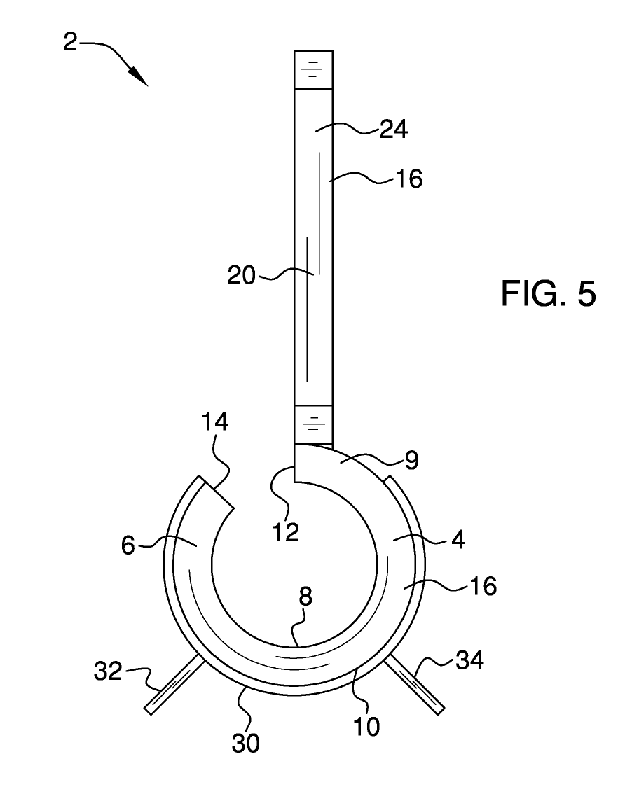

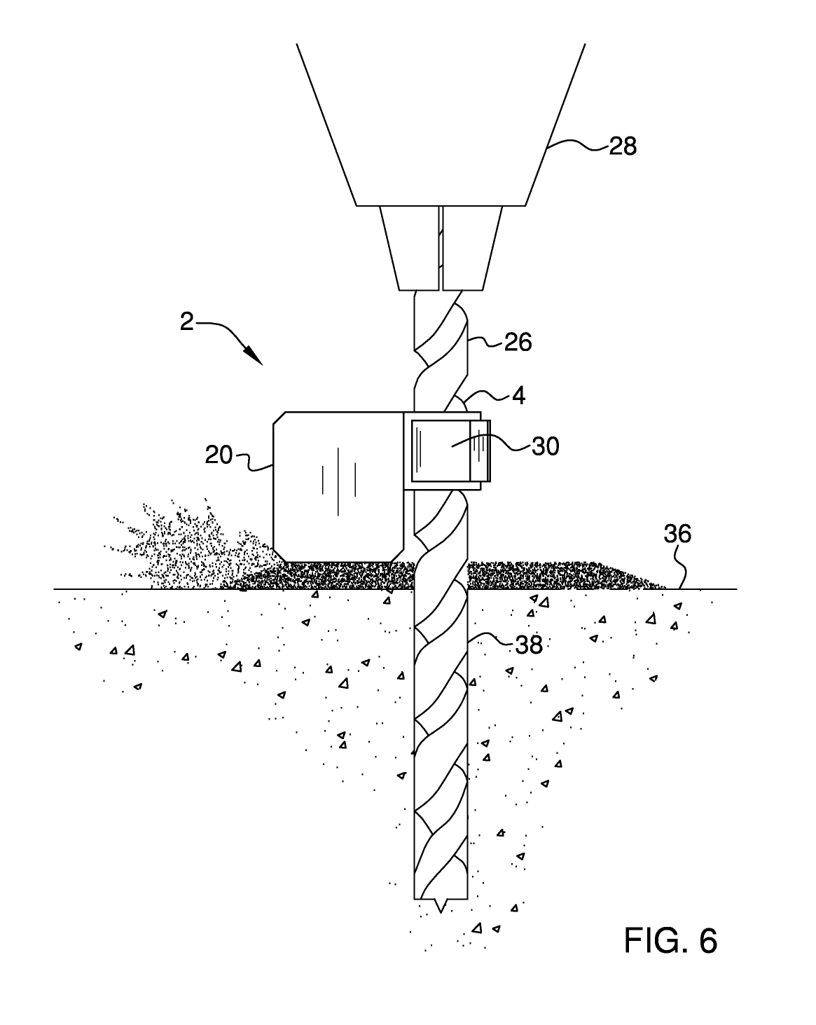

With reference now to the drawings, and in particular to FIGS. 1 through 6 thereof, a new electric drill attachment 2 embodying the principles and concepts of the present invention and generally designated by the reference numeral 2 will be described.

As best illustrated in FIGS. 1 through 6, the electric drill attachment 2 comprises a looped section 4, with the looped section 4 comprising a loop 6 that has two surfaces comprising an inner surface 8 and an outer surface 10. The loop 6 also a top surface 7 and a bottom surface 9, each of which are connected to both the inner surface 8 and the outer surface 10. The loop 6 on the looped section is not a complete loop, and thus, the loop 6 has two ends comprising a first end 12 and a second end 14. The loop 6 actually almost completes the circle, however, and travels approximately 315 degrees around a circular radius. This incomplete circle actually allows a small opening 18 to be present in between the first end 12 and the second end 14 of the loop 6.

Looped section 4 can be fabricated from a wide variety of materials. Preferably, however, it is fabricated from rubber 16.

A flat plate 20 extends outward and downward from the first end 12 of the loop 6, with the flat plate having a top edge 22 and a bottom edge 24. The top edge 22 is co-planar with the top surface 7 of the loop 6, with the bottom edge 24 of the flat plate 20 being located below that of the bottom surface 9 of the loop 6. When extending outward from the first end 12 of the loop 6, the flat plate 20 is perpendicular to the loop 6. The flat plate 20 is preferably fabricated from rubber 29.

In use, the loop 6 of the looped section 4 is fixedly attached to a drill bit 26 that is attached to a drill 28. The drill 28 is a hand-held drill and preferably is an electric drill. The loop 6 is kept secure by a spring clip 30 that is bonded to the loop 6. The spring clip 30 can be easily grasped and utilized by a pair of external tabs 32 and 34, allowing easy installation and removal of the attachment 2 on the drill bit 26. The spring clip 30 is used to maneuver the loop 6 into a secure position in relation to the drill bit 26 once the drill bit 26 has been placed within the loop 6.

By attaching the attachment 2 to the drill bit 26, the attachment 2 can serve as a bit of a depth gauge when drilling into a particular surface 36. When attaching the attachment 2, an individual can measure the desired depth of the hole 38 to be drilled by affixing the attachment in such a manner that the bottom edge 24 of the flat plate 20 is a specified distance above the level of the surface 36. Furthermore, once an individual is closing in on the depth of the desired hole 38, the flat plate 20 will act as a sweeping device to sweep away debris and shavings 40 from the area surrounding the hole 38 during drilling operations.

With respect to the above description then, it is to be realized that the optimum dimensional relationships for the parts of the present vehicle air freshener device to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What I claim as my invention is:

1. An electric drill attachment for attachment to a drill bit, the electric drill attachment comprising
(a) a flat plate, the flat plate having two edges comprising a top edge and a bottom edge, and
(b) means for attaching the flat plate to a drill bit that is attached to a hand-held drill.

2. An electric drill attachment for attachment to a drill bit according to claim 1 wherein the means for attaching the flat plate to a drill bit that is attached to a hand-held drill further comprises
(a) a looped section attached to the flat plate,
(b) means for attaching the looped section to the drill bit, and
(c) means for tightening the contact between the looped section and the drill bit once they have been attached to one another.

3. An electric drill attachment for attachment to a drill bit according to claim 2 wherein the means for attaching the looped section to the drill bit further comprises
(a) a loop connected to the looped section, the loop having two surfaces comprising an inner surface and an outer surface, the loop further including a top surface connected to both the inner surface and the outer surface, the loop further including a bottom surface connected to both the inner surface and the outer surface, the loop further including two ends comprising a first end and a second end,
(b) wherein the first end of the loop is attached to the flat plate.

4. An electric drill attachment for attachment to a drill bit according to claim 3 wherein the top edge of the flat plate is co-planar with the top surface of the loop.

5. An electric drill attachment for attachment to a drill bit according to claim 4 wherein the bottom edge of the flat plate is not co-planar with the bottom surface of the loop.

6. An electric drill attachment for attachment to a drill bit according to claim 5 wherein the flat plate extends away from the first end of the loop in a perpendicular manner.

7. An electric drill attachment for attachment to a drill bit according to claim 6 wherein the means for attaching the looped section to the drill bit further comprises
(a) an opening located in between the first end and the second end of the loop,
(b) wherein the circle travels approximately 315 degrees around a circular radius in between the first end of the loop and the second end of the loop.

8. An electric drill attachment for attachment to a drill bit according to claim 7 wherein the means for tightening the contact between the looped section and a drill bit once the looped section and a drill bit have been attached to one another further comprises
(a) a spring clip attached to the loop,
(b) a pair of tabs comprising a first tab and a second tab, the pair of tabs being attached to the spring clip,
(c) wherein the spring clip can be used to maneuver the loop into a secure position in relation to the drill bit once the drill bit has been placed within the loop.

9. An electric drill attachment for attachment to a drill bit according to claim 8 wherein the looped section and the flat plate are fabricated from a flexible substance.

10. An electric drill attachment for attachment to a drill bit according to claim 9 wherein the looped section and the flat plate are fabricated from rubber.

11. An electric drill attachment for attachment to a drill bit according to claim 10 wherein an individual can measure the desired depth of a hole in a flat surface to be drilled by attaching the electric drill attachment to a drill bit at a specific height and then drilling said hole until the bottom edge of the flat plate is co-planar with the flat surface.

12. An electric drill attachment for attachment to a drill bit, the electric drill attachment comprising
(a) a flat plate, the flat plate having two edges comprising a top edge and a bottom edge, and
(b) means for attaching the flat plate to a drill bit that is attached to a hand-held drill, said means further comprising (i) a looped section attached to the flat plate, (ii) means for attaching the looped section to the drill bit, said means further comprising (1) a loop connected to the looped section, the loop having two surfaces comprising an inner surface and an outer surface, the loop further including a top surface connected to both the inner surface and the outer surface, the loop further including a bottom surface connected to both the inner surface and the outer surface, the loop further including two ends comprising a first end and a second end, wherein the top edge of the flat plate is co-planar with the top surface of the loop, wherein the bottom edge of the flat plate is not co-planar with the bottom surface of the loop, wherein the flat plate extends away from the first end of the loop in a perpendicular manner, wherein the first end of the loop is attached to the flat plate, and (2) an opening located in between the first end and the second end of the loop, wherein the circle travels approximately 315 degrees around a circular radius in between the first end of the loop and the second end of the loop, and (iii) means for tightening the contact between the looped section and the drill bit once they have been attached to one another, said means further comprising (i) a spring clip attached to the loop, (ii) a pair of tabs comprising a first tab and a second tab, the pair of tabs being attached to the spring clip, (iii) wherein the spring clip can be used to maneuver the loop into a secure position in relation to the drill bit once the drill bit has been placed within the loop,
(c) wherein the looped section and the flat plate are fabricated from a flexible substance, said flexible substance preferably being rubber.
